(19) United States
(12) Patent Application Publication
(10) Pub. No.: US 2009/0160930 A1
(43) Pub. Date: Jun. 25, 2009

(54) Method for Recording Digital Images

(76) Inventor: Wilhelm Ruppert, Köln (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/086,101

(22) PCT Filed: Dec. 5, 2006
(86) PCT No.: PCT/EP2006/069325

§ 371 Date: Jun. 5, 2008

(30) Foreign Application Priority Data
Dec. 6, 2005 (DE) 10 2005 058 353.9

(51) Int. Cl. H04N 7/00

(52) U.S. Cl. 348/37; 348/E09.002

(57) ABSTRACT

A device and a method for recording digital images which represent objects, in particular, motor vehicles, from various angles of observation is disclosed. According to the system described herein, a method for recording images with a qualitatively high resolution image of objects from various angles of observation may be rapidly achieved with generation of minimal data by means of carrying out the following steps: arranging the object on a turntable, continuously rotating the turntable, generating electronic trigger signals on rotating the turntable in given angular positions of the turntable, transmitting the trigger signals to a controller of a digital camera and recording an image with the digital camera on receipt of a trigger signal.

### TECHNICAL FIELD

The invention relates to a method for recording digital images of objects to be represented, in particular motor vehicles, from various observation angles, and a device for carrying out such a method.

Such recordings are frequently used for the presentation of objects which are offered for sale. In particular, motor vehicles are presented on the Internet in a so-called 360° view. In this manner the observer may view the vehicle from all sides. The observed vehicle appears able to be rotated in the representation on the monitor.

However, such a representation is not limited to vehicles, and may be used for the presentation of any other given objects. It is customary to take individual recordings of the objects to be represented. This is a complicated and time-intensive procedure, since producing a recording of the vehicle in every observation angle requires the recording camera to be prepared and adjusted each time.

The PDF file “KAIDAN Meridian MT84—User's Guide” posted on the Internet site www.kaidan.com discloses a recording system which operates using a turntable. The cited document defines the starting and ending positions of the turntable motion, into which the turntable is moved as the recording is performed. In addition, an increment is defined which is the angular distance for moving the unit by automatic control. Thus, the unit is advanced by the increment before a new recording is made. The waiting period before a motion to a new position is initiated may be specified by inputting a “delay” value for the turntable. When a panoramic view, for example in angular increments of 10°, is generated, the turntable of this device must be accelerated and then decelerated 36 times. This is very time-consuming, and for taking recordings of heavy objects such as passenger vehicles requires the use of very high-power drives and brakes.

### DISCLOSURE OF THE INVENTION

The object of the invention is to provide a recording method which allows high-quality recordings of objects from various observation angles to be made rapidly and with minimal generation of data.

This object is achieved by use of the method, which includes the following steps:
Placing the object on a turntable;
Continuously rotating the turntable;
Generating electronic trigger signals in given angular positions of the turntable while the turntable is rotated;
Transmitting the trigger signals to a control device for a digital camera; and
Recording an image using the digital camera upon receipt of a trigger signal.

In other words, all recordings in the various observation angles are taken by a stationarily situated camera, the object to be represented being placed on a turntable which is continuously rotated, and during the rotation, trigger signals are generated in given angular positions which cause an image recorded by the digital camera to be stored. The camera is preferably a video camera which transmits a video data stream to a control device for the camera. Video cameras are usually equipped with CCD image sensors for recording the image. Upon receipt of a trigger signal, the control device stores an individual frame from the video data stream in a data memory device. Such a function is also referred to as “frame grabbing”; i.e., the data stream containing individual video frames is continuously fed to an input interface of the control device, which upon receipt of given signals stores individual frames.

The method according to the invention allows a panoramic view of the object to be represented to be generated in a very efficient and rapid manner. To record the necessary images, the turntable together with the object to be represented need undergo only one complete 360° revolution. The rotational speed is selected in such a way that the motion of the object does not impair the quality of the recording. For example, the complete revolution may last approximately 30 to 60 seconds. Such low rotational speeds of the vehicle do not impair the quality of the recording. Since the turntable is continuously rotated as the recordings are made, and need not be accelerated and decelerated for each individual recording, the turntable is subject to minimal mechanical stress during the recordings, and a very high drive power for the turntable is not necessary.

In practice, it has been found that a continuous frame sequence is not necessary for visually appealing presentations of objects such as vehicles. A frame sequence containing individual frames, in which the observation angle differs by 10° in each case (i.e., 36 individual frames for a 360° rotation of the object) is sufficient for a high-quality, attractive presentation of the object. The advantage of the triggered individual recordings compared to recording a continuous video data stream of the rotated object lies in the significant reduction of generated data for the complete 360° view. During the recording, only the exact number of frames are generated which are necessary for an attractive presentation of the object. The number of images generated per object may be adapted to the requirements for presentation quality. It is not necessary to reduce the amount of data that is present by deleting individual portions of the data stream in subsequent processing of a stored data stream. In this manner significant cost savings may be realized for the data processing devices which are used to carry out the method according to the invention.

Any digital camera having an image capture sensor and which may be automatically controlled via signal inputs may be used as a recording chamber. In practice, a video camera used in object monitoring has proven to be satisfactory. Such a video camera has an IEEE 1394 interface, also referred to as a FireWire interface. By use of this interface, control signals may be sent to the camera, and image data streams may be sent in real time from the camera to electronic control devices or data memory devices.

In the method according to the invention, the control device may actuate other devices besides the camera upon receipt of the trigger signal. For example, a flash may be actuated so that at the time that an individual frame is stored the object to be recorded may be provided with particularly bright illumination.

As mentioned above, all images are recorded while the turntable continuously rotates. The recording process is ended upon passage through a predetermined angle. This predetermined angle is preferably 360°. In this case a panoramic view of the object to be recorded is generated.

Each of the recorded images is preferably stored in a digital data memory device in conjunction with an identifier which is uniquely associated with the object. The method according to the invention may advantageously be used for producing presentation displays for objects to be sold, in particular used vehicles. Such used vehicles are frequently presented on Internet sites of automobile dealers or sales platforms. In addition to the images, technical data and other information concerning the imaged object are presented. These data are preferably stored in a data record. The data record contains an identifier which matches corresponding identifiers for the stored images. It is particularly preferred to use file names which have matching identifiers. Thus, the first eight or nine characters of a file name may be provided with a unique character string which is associated with a specific vehicle. This character string appears in the file names for the vehicle data as well as in the file names of the individual frames. These initial characters are followed by a number of additional characters (three or four, for example) which identify the specific contents of the various data records (for example, recording at a rotational angle of 0°, recording at a rotational angle of 10°, recording at a rotational angle of 20°, etc., an individual shot of the interior, an individual shot of important features of the vehicle such as wheel rims, etc.).

In conjunction with the images in various rotational angles, additional individual recordings which are manually generated may be stored. When the object to be represented is a vehicle, individual recordings are preferably taken of the passenger compartment and optional features, for example special wheel rims on the vehicle. As mentioned above, all individual recordings and additional data records generated for a given vehicle are associated with one another using unique identifiers.

In one preferred embodiment of the method according to the invention, each of the recorded images is compared to a reference image of the turntable without the object thereon, and the background is deleted from the recorded image. In this manner a frame sequence of the object to be represented may be generated in various observation angles, free of distracting objects in the vicinity of the recording. This frame sequence may be combined with any given background, thus allowing presentation of the recorded 360° frame sequence against various backgrounds selected by the user. For deletion of the background, pixels of the recorded image which correspond to matching pixels of the reference image within predetermined limit values may be deleted. Furthermore, in practice a reference image may be recorded for each angular position in which the turntable generates an electronic trigger signal, the reference image being used in a given angular position for postprocessing an object recording in the identical angular position.

In practice, a recording series is performed on an empty turntable before an object such as a motor vehicle is recorded. The turntable passes through all rotational positions without an object thereon, and thus records a reference frame sequence in the various rotational angles at which trigger signals are emitted. When a vehicle or another object is subsequently placed on the turntable, the turntable is always in the angular position in which it is located in the generation of the reference recording. In this manner structures or color changes of the turntable cannot cause corruption of the extracted object image. Such structures or color changes are in the same rotational position in the reference recording as in the object recording, and are deleted from the background. It is necessary only to produce a new set of reference recordings from time to time, since the surface and the structure of the turntable as well as the background of the recording room generally change very little over time.

In practice, the control device may be coupled to a closing mechanism for at least one entrance into the recording room in which the turntable is situated. The control device actuates the closing mechanism, thereby closing the entrance to the recording room as soon as a recording process begins operation. This ensures that a person or animal enters while the recordings are being made.

Furthermore, in practice a closing sensor may be provided on a closing mechanism for at least one entrance into the recording room, the closing sensor being coupled to the control device and emitting a signal when the closing mechanism is closed. The control device permits a recording process to be carried out only when the signal indicating the closed state of the entrance is received. The control device blocks the recording process until this signal is received. This ensures that the recording is performed only when the entrance is closed. On the one hand, this prevents a person or object from moving into the recording area during the recording. On the other hand, interfering light from the outside is prevented from entering the recording room through the entrance. In this manner the same lighting conditions are always present in the recording room, due to the artificial lighting used in this room. This ensures that the background of the reference recording is essentially identical to the background of an object recording, and may be effectively deleted from the recorded representation in the deletion process described above.

The turntable may be driven by a motor when the method is used for generating images of heavy objects, for example motor vehicles. For light objects, small turntables may be used which are set in rotation manually.

Besides the digital camera described above, additional digital cameras which are actuated by the control device may be provided, which upon receipt of a trigger signal make a recording of the object from another perspective than that of the first-referenced camera. These images as well are stored on a hard drive. Thus, in addition to a first set of 360° images, which is usually recorded from a slightly elevated position (a camera height of 200 to 250 cm, for example), a second set of 360° images is recorded, for example, from a so-called worm's eye view (camera height approximately 50 cm). In this manner multiple sets of digital 360° images may be generated simultaneously without extending the duration of the recording process. Of course, the above-described deletion process, which suppresses the background from the recorded frames, may also be applied to this second set of images.

It is also possible to control a zoom lens of at least one of the cameras. For example, before each recording of a set of images the zoom lens may be adjusted in such a way that the object to be recorded optimally fills the frame. For this purpose, for example, the object may be recorded in the view having the largest dimensions, and the zoom lens for the camera adjusted in such a way that these largest dimensions extend over the entire image. The zoom lens may also be adjusted after each recording, so that the camera is zoomed toward or away from the recorded object during the 360° rotation. Lastly, a second recording may also be taken with an adjusted zoom lens immediately after each recording, thereby generating two sets of images with different zoom factors, using one camera. When the above-described method is used for deleting the background, for each of the zoom factors it is important to record a reference image, which is used for deleting the background of an image having the same zoom factor. If the image sensor for the digital camera allows a sufficiently high resolution to be recorded, the zoom function may also be implemented digitally. Frame files may be generated in which only a segment of a recorded frame is stored, thereby achieving a higher zoom factor. However, digital zoom results in a reduction in the image quality, and can be performed only up to a given limit value.

The invention further relates to a device for recording digital images, by use of which the above-described method may be carried out. This device includes:
a turntable which may be continuously rotated;
a trigger device associated with the turntable, which generates electronic trigger signals in given angular positions of the turntable while the turntable (9) is rotated;
a digital camera;
a control device for controlling the camera;
transmission means for transmitting the trigger signals from the trigger device to the control device; and
a data memory device for storing the image recorded by the digital camera upon receipt of a trigger signal.

The device may also include additional devices such as flashes, which are actuated by the control device upon receipt of the trigger signal. The device may also include an interface for connecting a manually operable digital camera. The video camera for generating the images in various rotational angles should be rigidly mounted in the recording room so that it cannot be removed by a person. Reliable automatic generation of a frame sequence in various rotational angles and effective suppression of the background according to the method described above is ensured only when the camera positions and recording areas match exactly. For manual recording, a second camera must be used which is connected to the device according to the invention via the above-named interface.

The device also preferably has input means using which data records associated with the recorded object may be input. For vehicles, input means such as a keyboard and mouse are used to input preferably technical data concerning the vehicle and the sales price and to store same as a data record. The device in particular may have an interface for connection to a digital data network (Internet). In this manner, existing data records concerning the object to be recorded may be transferred, or transmitted to the device. Furthermore, communication of the recording device via the Internet is helpful for image processing and posting the processed images on the Internet.

The device may also include an image processing computer having at least one data memory device and a processor used for processing the recorded images. Since processing the images may be time-consuming, the image processing computer may be separate from the control device for performing the recording. In particular, the image processing computer is connected to the data memory device for the recording device via a digital data network such as the Internet. After a frame sequence is recorded, the control device for the device according to the invention initiates transmission of the frame sequence via the Internet to an image processing computer. The transmission process may be performed relatively quickly, since only a small quantity of data is present as a result of the triggered recording in discrete angles. Thus, the time-intensive postprocessing of the recording sequence does not interfere with the subsequent process of recording a new frame sequence.

In practice, the device according to the invention may include the closing mechanism mentioned above, as well as a closing sensor for the closing mechanism.

For moving heavy objects, in practice the turntable may be coupled to an electrically operated motor.

As previously mentioned, the device preferably has an interface for connection to a digital data network such as the Internet. As discussed above, in this manner it is possible, for example, to separate the image processing from the image recording. Remote control and remote monitoring of the device according to the invention are also possible.

### BRIEF DESCRIPTION OF THE DRAWINGS

Specific embodiments of the invention are described below with reference to the appended drawings.

FIG. 1 shows a schematic illustration of a recording room for carrying out the method according to the invention;

FIG. 2 shows a schematic illustration of the elements of the device according to the invention for carrying out the method according to the invention;

FIGS. 3 through 5 show schematic illustrations for explaining the suppression of the background from the recordings generated according to the invention; and

FIG. 6 shows a schematic lighting system for a device according to the invention.

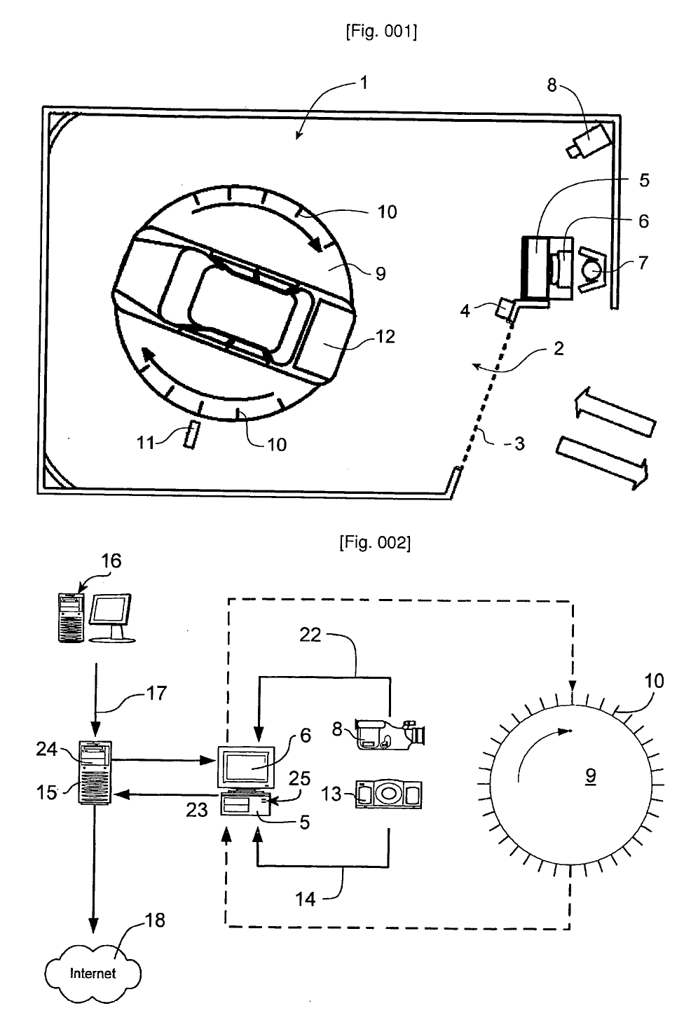

FIG. 1 illustrates a top view of recording room 1 in which the recording method according to the invention is carried out. Recording room 1 has an entrance 2 through which persons may enter recording room 1, and motor vehicles 12 to be recorded may be driven in and out.

Entrance 2 may be closed by a high-speed door 3. High-speed door 3 is preferably motor-driven, and may either be raised and lowered, or laterally moved away from entrance 2. Provided at a suitable location is a closing mechanism 4 which is able to lock high-speed door 3 in the closed position. Closing mechanism 4 includes a sensor which is able to detect the state of closing mechanism 4. The signal of the sensor allows a determination to be made at any time as to whether entrance 2 is closed or open.

The entire recording process, including the actuation of high-speed door 3, is controlled by a computer 5, which constitutes the control device for carrying out the recording method according to the invention. In a known manner computer 5 includes a display device, which in particular is designed as a touch screen 6. By use of touch screen 6 an operator 7 may send commands to computer 5 which control the recording process and in particular initiate an automatic recording according to the invention.

In addition, a video camera 8 is fixedly mounted in recording room 1, and records a motor vehicle 12 in various observation angles. Video camera 8 is connected to computer 5 via a high-speed data line (FireWire, for example). Computer 5 transmits control signals to video camera 8 via this data line, and receives recorded images from video camera 8 and stores same on a mass storage device, in particular a hard disk drive 23.

Video camera 8 is oriented in such a way that it records, at an oblique angle from above, the space above a turntable 9 in recording room 1. Such turntables 9, which have a load capacity of 2 tons or more, are known from trade fair construction, for example, where they are used for presentation of rotating motor vehicles. The turntables are driven by at least one electric drive motor, and are supported on roller bearings to be rotatable about their center point. Turntable 9 is composed of a circular, solid support plate made of wood or plastic, for example. A drive motor beneath turntable 9 sets turntable 9 in rotational motion.

Computer 5 is connected to the electronic control system of the motor via a suitable data line, and switches the motor on or off as needed. Markings 10, illustrated as short lines, are provided on the turntable. Markings 10 cooperate with a detection unit 11 associated with turntable 9. Detection unit 11 constitutes a trigger device. For example, markings 10 may be designed as recesses in the material of turntable 9, it being possible for detection unit 11 to be formed by a photoelectric barrier. A signal is generated each time a recess passes the photoelectric barrier. This signal is transmitted as a trigger signal to computer 5 via suitable signal transmission means. It is noted that the connection to the individual devices may be achieved not only via electrical printed circuit boards, but also via radio links, infrared links, or similar signal transmission links.

In addition, a photoelectric barrier represents only one example of a system for generating a trigger signal. Other markings 10 may be used, for example permanent magnets, mirrors, or the like, which may be detected using appropriate detection units, so that a trigger signal is generated when a marking 10 is near detection unit 11. Furthermore, it is not absolutely necessary to affix markings 10 directly to turntable 9. A detection unit for the rotational angle may also be provided on the drive motor. For example, a circular marking disk having light-permeable or reflective sections which alternate with light-impermeable or nonreflective sections may be mounted on the motor shaft, an optical detection unit detecting the alternation between two consecutive, differing sections. Such a signal transmitter allows the rotational position and the rotational speed of the motor shaft to be detected with practically any given precision. The motor shaft is connected to the turntable either directly or via gearing. Thus, a given rotational angle of the motor shaft may be uniquely associated with a given rotational angle of turntable 9. Of course, the rotational angle may also be detected at a shaft of the gearing or at a gearwheel of this gearing.

It is not necessary for the rotational angle detection to determine the rotational motion of turntable 9 at the same angular distances which are situated between two trigger signals. The rotational angle may also be detected at a much higher resolution. This occurs automatically when the motor is coupled to turntable 9 via a step-up gear. Depending on the resolution of the detection unit for the rotational angle detection and the step-up between turntable 9 and the location where the rotational angle is detected, hundreds or thousands of signal pulses may be detected between two trigger signals. The specific number of signal pulses between two trigger signals is specified for identical successive angular segments. The rotational angle between two trigger signals may be selected over a very wide range by high-resolution detection of the rotational position of turntable 9. An angular distance which varies over the circumference of turntable 9 may also be achieved between two trigger signals. For example, it may be advantageous to record certain views in small angular increments, and to record other views in large angular increments. This could be achieved, for example, using markings 10 on turntable 9 which have different angular distances from one another. It is much easier to achieve variable triggering by high-resolution detection of a rotational motion, the various rotational positions of turntable 9 together with the accuracy of the resolution of the rotational motion detection being freely selectable and programmable.

The system in recording room 1 allows a panoramic view of a vehicle situated on turntable 9 to be produced extremely quickly and automatically. The recording process proceeds as follows:

1. Driving the vehicle through entrance 2 and onto turntable 9;

2. Closing high-speed door 3;

3. Assigning a unique identifier (motor vehicle ID) to the vehicle on the turntable at the time;

4. Starting the recording process by an operator 7, who makes a corresponding input into control device 5;

5. Actuating the drive motor of turntable 9 using control device 5 to set turntable 9 in continuous rotation;

6. Storing the frame recorded by camera 8 at the moment at which a first trigger signal is transmitted by detection unit 11 to control device 5;

7. Storing the frame recorded by camera 8 at the moment at which a second trigger signal is transmitted by detection unit 11 to control device 5, and detecting frames for all further trigger signals until turntable 9 has made a 360° revolution;

8. Opening high-speed door 3 and driving motor vehicle 12 out; and

9. Optionally associating at least one vehicle data record with the motor vehicle ID.

It is to be noted that the motor vehicle ID may be assigned by inputting an alphanumeric identifier via a keyboard, or by any other given method. For example, when the motor vehicle is driven in, a data record associated with the vehicle may be loaded from a computer of a motor vehicle dealer connected via a data network. This may be performed by manually retrieving the data, or by reading in a bar code affixed to the vehicle, using a bar code scanner. A unique information item from the vehicle data record may be used as the motor vehicle ID, for example the chassis number. This may be used, for example, as a component of each file name of the individual files generated using the method according to the invention. Thus, step number 8, involving the association of at least one vehicle data record with the motor vehicle ID, may coincide with step 3 of assigning the motor vehicle ID, by the fact that the ID assigned to the vehicle is taken from the vehicle data record and is thus automatically assigned to this data record.

As mentioned above, after turntable 9 has stopped, operator 7 may take additional detailed shots of motor vehicle 12, using a manually operable digital camera. For example, the interior, wheel rims, and other special features of motor vehicle 12 may be recorded on photographs taken by hand. Computer 5 for controlling the recording system has a standard interface, for example a USB interface, via which a camera may be connected. The software running on computer 5 reads out the image data from the camera and displays them to operator 7 on display device 6. Operator 7 may select the displayed images by inputting (for example, by a mouse click or by using a touch screen), and store same together with the images of the panoramic view of motor vehicle 12. The control program is adjusted in such a way that all image data read out via a data interface before the end of a recording operation are associated with the vehicle for which the 360° recordings have been made during the same recording process.

In order to make the highest quality recording possible of motor vehicle 12, the interior walls of the recording room should be as uniform as possible. The floor of recording room 1 is preferably provided with a light, matte-surface floor covering. The walls of recording room 1 should likewise have a light, low-reflective covering. For example, matte aluminum sheets are suitable for covering the walls of recording room 1. Such aluminum sheets may be glued without joints, so that the walls of recording room 1 cause little interference with the recording.

Lastly, a second video camera may be provided, directly below illustrated video camera 8 or at another location in recording room 1, which upon receipt of a trigger signal is actuated by control device 5 to record an image from a perspective different from that of first video camera 8.

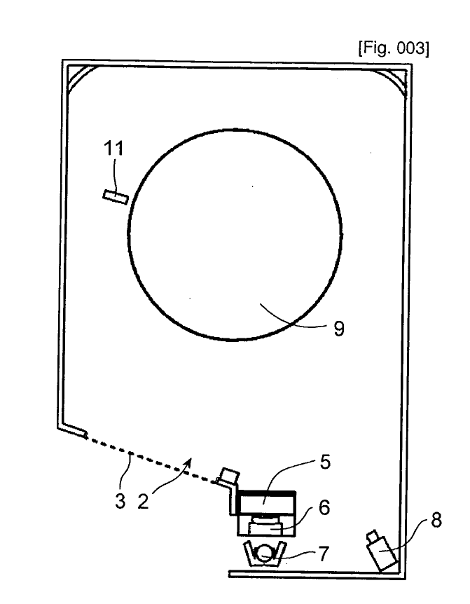

FIG. 2 shows, once again, cooperating components of the recording system according to the invention. In the figure, identical components are denoted by the same reference numerals as in FIG. 1.

Firstly, associated with schematically illustrated turntable 9 are thirty-six markings 10 which generate trigger signals when the turntable undergoes rotational motions in uniform angular distances of 10°. The trigger signals are transmitted to computer 5, which is provided in recording room 1 as a control device. Video camera 8 is connected to computer 5 via a FireWire data line 22. As mentioned above, the video camera is fixedly mounted in the recording room and is focused on turntable 9. It is noted that data links other than FireWire may be used for connecting video camera 8. It is important to ensure a sufficiently high transmission speed for the frames recorded by video camera 8.

FIG. 2 also shows a manually operable digital photo camera 13. Operator 7 may record detailed images of motor vehicle 12 using this digital photo camera 13. Digital photo camera 13 may be connected to computer 5 via a USB data cable 14. Schematically illustrated on the front side of computer 5 are two USB interface ports 25 in which the plug of USB data cable 14 may be inserted. Here as well, it is noted that any other data cable may be used, by which the camera may be connected to a suitable interface (for example, a serial interface, parallel interface, or FireWire interface) present at computer 5. Software is installed on computer 5 which automatically downloads the images from photo camera 13 during an activated recording process and associates the images with the same motor vehicle ID as for the 360° images recorded in this recording process.

After the recording process has concluded, which is indicated by the operator, for example, by actuation of a control switch, a key, or a region of touch screen 6, computer 5 transmits the recorded frame data to an image processing computer 15. Any data network having adequate speed is suitable for this transmission. When image processing computer 15 is spatially associated with computer 5 for controlling the recording, a local area network (LAN), for example, may be used for the data transmission. However, image processing computer 15 may also be at a remote location with respect to computer 5 used for control. In this case the data are transmitted to image processing computer 15 via the Internet.

This data transmission lasts only a few minutes, since the recording method according to the invention ensures that an excessive quantity of data is not present. The 360° view requires only thirty-six individual recordings. Another four or five individual recordings for displaying details are generally sufficient. These frame data may be transmitted to image processing computer 15 in a time period that is shorter than the time required for driving vehicle 12 (FIG. 1) from recording room 1 and driving the next vehicle into recording room 1.

After the recorded frames have been transmitted to image processing computer 15, computer 5 is available once again for controlling another recording sequence.

FIG. 2 shows a further vehicle data computer 16, in which, for example, the manufacturer or a dealer has stored the data for imaged vehicle 12. The vehicle data records may be transmitted as described above, using a suitable data connection, preferably before the recording process starts, to computer 5 which is controlling the recording, or to image processing computer 15. Image processing computer 15 may also perform image data archiving and management. For the image data archiving and management, image processing computer 15 may be coupled to a large data memory device such as a hard disk drive 24 in the range of over 1 terabyte, on which numerous recorded images may be stored. The image processing computer may also be part of a local computer network in which various computers are present and interconnected for different tasks (for example, the first computer for image processing, the second for web hosting, and the third for archiving).

Of course, it is also possible to record the images first, and then input the vehicle data or download same from another computer.

The combined data records, composed of the 360° recording, the detail images, and the vehicle data records, are then made available via Internet 18 to buyers, who by clicking on a Web site of the dealer or manufacturer are able to view the vehicle data as well as the images of motor vehicle 12 (FIG. 1) automatically produced using the method according to the invention. Of course, the recorded images may also be presented elsewhere than on the Internet. For example, the recordings may be combined into small presentation films which are displayed on large monitors or video screens in a presentation room of an automobile dealer or manufacturer.

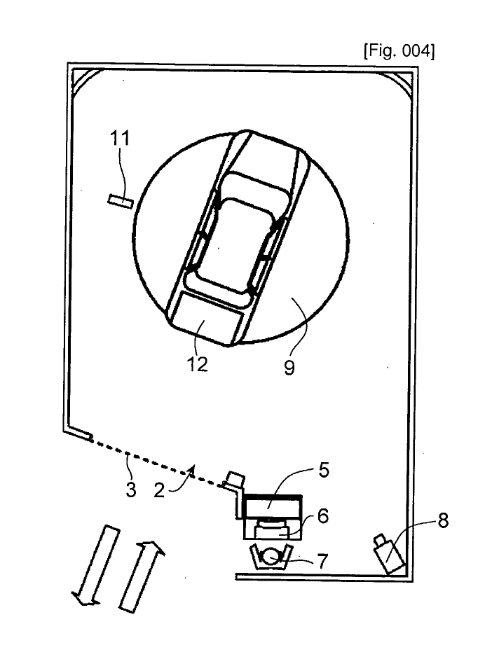

To enhance the visual presentation of the recorded images, the vehicle is isolated from the background in the 360° frame sequence recorded. The procedure for isolating the vehicle is shown in FIGS. 3 through 5. In a first step, the recording system records a reference image of the recording room, using video camera 8. During the recording of the reference image there is no vehicle on turntable 9 (see FIG. 3). When turntable 9 is composed of a clean, homogeneous surface, a single reference recording may be used to isolate the vehicle from each image in the 360° frame sequence. For this purpose, the individual pixels of the image of vehicle 12 are compared to the pixels of the reference recording. Multiple color values are associated with each pixel. In the regions in which no vehicle is displayed on the image, the pixels essentially match those of the reference recording.

In practice, turntable 9 frequently does not maintain its homogeneous surface over a long period of time. Tire tracks and other colored markings appear on the surface after a long period of use. For this reason, with the turntable empty a complete image sequence of reference images is recorded for the various angular positions in which a trigger signal is emitted. Each reference image is used to delete the background of a vehicle image for an identical angular position.

FIG. 5 schematically illustrates the results when matching pixels in the views of FIGS. 3 and 4 (reference image without vehicle and identical image with vehicle) are removed.

Of course, shadows of the vehicle remain after the background is removed. However, these are desirable, since a rotating body without shadows does not appear natural. However, a small shadow with uniform lighting of the vehicle is generally preferred. For this reason the ceiling of recording room 1 should be provided with bright lighting.

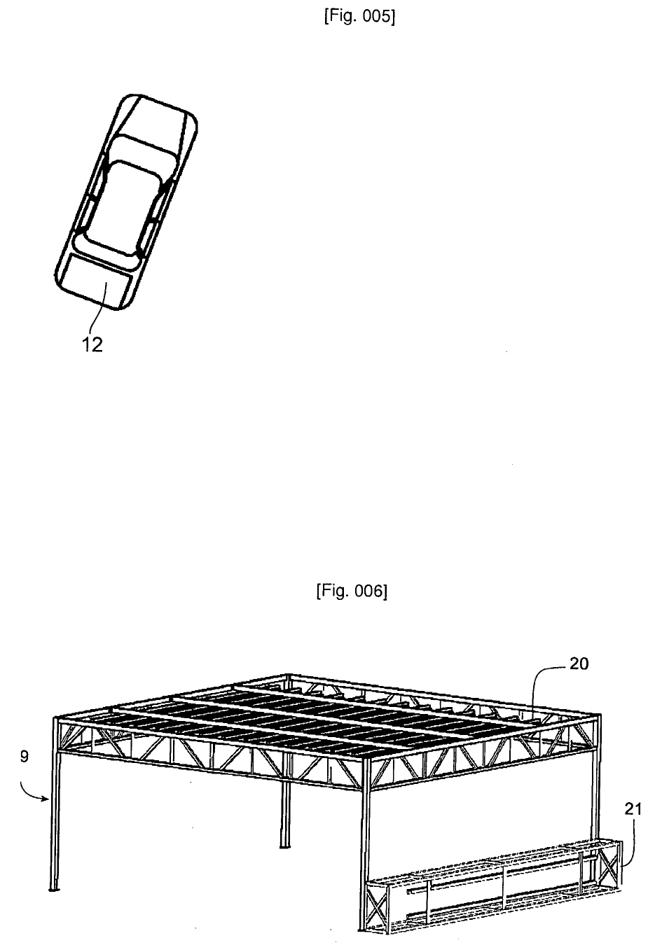

FIG. 6 shows a support frame 19, which is used as the structure of a recording room. In the upper section, support frame 19 bears numerous lights in which high-power fluorescent lamps 20 are provided for illuminating the recording room below. The powerful illumination from above ensures the formation of a small shadow directly beneath the vehicle. On the side on which video camera 8 is mounted, a holding frame 21 is provided in the lower region of the support frame (up to a height of approximately 0.80 m) for illuminating from the front. This lighting from the direction of the camera reduces the formation of shadows and improves the illumination of the vehicle.

By use of support frame 19 shown in FIG. 6, a recording room 1 may be constructed to be stationary as well as transportable. In the stationary version, support frame 19 is anchored in a concrete foundation and provided, for example, with metal side walls and a roof structure. For transportable use, support frame 19 may be provided in the manner of a tent, with a roof panel and side panels. In this manner the recording device according to the invention may be used for recording objects in a larger geographical area. For example, a group of dealers may share a single recording room, each dealer in alternation setting up the recording room on site at his place of business for a given time period and providing said recording room with the other devices for performing the recording according to the invention.

### LIST OF REFERENCE NUMERALS

1 Recording room
2 Entrance
3 High-speed door
4 Closing mechanism
5 Control device, computer
6 Display device, touch screen
7 Person
8 Video camera
9 Turntable
10 Marking
11 Detection unit, trigger device
12 Object, motor vehicle
13 Digital photo camera, digital camera
14 USB data cable
15 Image processing computer
16 Vehicle data computer
17 Data connection
18 Internet
19 Support frame
20 Lights
21 Holding frame
22 FireWire data line
23 Hard disk drive, data memory device
24 Hard disk drive, data memory device
25 USB interface port

1. A method for recording digital images of an object from various observation angles, comprising:
placing the object on a turntable;
rotating the turntable;
generating at least one electronic trigger signal in given angular positions of the turntable while the turntable is rotating;
transmitting the at least one trigger signal to a control device for a digital camera; and
recording an image with the digital camera when the at least one trigger signal is received.

2. The method as recited in claim 1, that wherein a video data stream is transmitted from the camera to the control device, and wherein, when the at least one trigger signal is received, the control device removes an individual frame from the video data stream and stores the frame in a data memory device.

3. The method as recited in claim 1, wherein, when the at least one trigger signal is received, the control device actuates additional devices.

4. The method as recited in claim 1, wherein the recording of the images is ended after the turntable has rotated by a given angle.

5. The method as recited in claim 4, wherein the given angle is 360°.

6. The method as recited in claim 1, wherein each of the recorded images is stored in a digital data memory device in conjunction with an identifier which is uniquely associated with the object.

7. The method as recited in claim 6, wherein at least one additional, manually recorded image is stored in the digital data memory device in conjunction with the identifier which is uniquely associated with the object.

8. The method as recited in claim 1, wherein each of the recorded images is compared to a reference image of the turntable without the object thereon, and a background is deleted from the recorded image.

9. The method as recited in claim 8, wherein, for deletion of the background, pixels of the recorded image which correspond to matching pixels of the reference image within predetermined limit values are deleted.

10. The method as recited in claim 1, wherein for each angular position in which the turntable generates an electronic trigger signal, a reference image is recorded which is compared to the image of the object recorded in the corresponding angular position of the turntable.

11. The method as recited in claim 1, wherein, as soon as a recording process begins operations the control device actuates a closing mechanism for at least one entrance into a recording room in which the turntable is situated.

12. The method as recited in claim 1, wherein the control device controls at least one additional camera, and the additional camera records an image when the at least one trigger signal is received.

13. The method as recited in claim 1, wherein the digital camera has a zoom lens which is controlled by the control device.

14. The method as recited in claim 1, wherein the control device is connected to a closing sensor of a closing mechanism for at least one entrance into a recording room, the closing sensor emitting a signal when the closing mechanism is closed, and the control device blocking the recording process until is the signal is received.

15. The method as recited in claim 1, wherein the turntable is driven by a motor.

16. A device for recording digital images of an object from various observation angles, comprising:
a rotatable turntable;
a trigger device associated with the turntable, which generates at least one electronic trigger signal in given angular positions of the turntable while the turntable is rotating;
a digital camera;
a control device for controlling the digital camera;
a transmission device for transmitting the at least one trigger signal from the trigger device to the control device; and
a data memory device for storing the image recorded by the digital camera when the at least one trigger signal is received.

17. The device as recited in claim 16, wherein the device includes additional devices which are actuated by the control device when the at least one trigger signal is received.

18. The device as recited in claim 16, further comprising:
an interface via which a manually operable digital camera is connected.

19. The device as recited in claim 16, further comprising:
input means for inputting data records associated with the object.

20. The device as recited in claim 16, further comprising:
an image processing computer having at least one data memory device and a processor for processing the recorded images.

21. The device as recited in claim 20, wherein the image processing computer is connected to the data memory device of the control device via a digital data network.

22. The device as recited in claim 16, further comprising:
a closing mechanism which is actuated by the control device.

23. The device as recited in claim 16, further comprising:
a closing sensor for a closing mechanism for at least one entrance into the recording room, the closing sensor emitting a signal to the control device when the closing mechanism is closed.

24. The device as recited in claim 16, wherein the turntable is coupled to a motor.

25. The device as recited in claim 16, further comprising:
an interface for connection to a digital data network, in particular the Internet (18).

26. The device as recited in claim 16, further comprising:
an additional digital camera which is controlled by the control device on the basis of the at least one trigger signal.

27. The device as recited in claim 16, wherein the digital camera has a zoom lens which is controlled by the control device.

28. The device as recited in claim 17, wherein the additional device include at least one of: a flash, a zoom lens and an additional digital camera.

29. The device as recited in claim 24, wherein the motor is an electric motor.

30. The device as recited in claim 16, wherein the rotatable turntable is a continuously rotating turntable.

31. The device as recited in claim 16, wherein the object is a motor vehicle.

32. The method as recited in claim 3, wherein the additional devices include at least one of: a flash, a zoom lens and an additional digital camera.

33. The method as recited in claim 1, wherein the turntable continuously rotates.

34. The method as recited in claim 1, wherein the object is a motor vehicle.
